(19) United States
(12) Patent Application Publication
(10) Pub. No.: US 2016/0134053 A1
(43) Pub. Date: May 12, 2016

(54) STRUCTURE OF SOCKET CONTACT

(71) Applicant: SMK CORPORATION, Tokyo (JP)

(72) Inventors: Atsushi ARAI, Toyama (JP); Akiko HONDA, Toyama (JP); Tetsuya TAKAGI, Toyama (JP)

(21) Appl. No.: 14/825,179

(22) Filed: Aug. 13, 2015

(30) Foreign Application Priority Data
Nov. 11, 2014 (JP) 2014-228969

(51) Int. Cl. H01R 13/631

(52) U.S. Cl. CPC H01R 13/631

(57) ABSTRACT

A structure of a socket contact that can establish connection with high connection reliability just by inserting core wire of a cable is provided. In the structure of a socket contact for connecting a core wire of a cable by insertion thereof, the socket contact includes a terminal contact for establishing electric connection with the core wire, and an elastic contact. The terminal contact has a contact portion for coming into contact with a side part of the core wire, and regulators erected on both sides of the contact portion in a width direction. The elastic contact has a retainer and a pusher for the core wire that are opposite to the contact portion of the terminal contact.

### CROSS REFERENCE TO RELATED APPLICATION

The contents of the following Japanese patent application are incorporated herein by reference,
NO. 2014-228969 filed on Nov. 11, 2014.

### FIELD

The present invention relates to a structure of a socket contact for connecting a core wire of a cable.

### BACKGROUND

For example, to connect a power cable of a power conditioner for a solar system or the like, a method is adopted in which a round contact is crimped to a core wire of the cable and then secured to a terminal board with a screw.

This method requires a large number of man-hours when making the connection in the field, and also tends to cause trouble owing to faulty screwing.

Patent Literature 1 discloses a terminal board into which core wires of cables are each inserted to establish connection at two portions i.e. a catching portion and a wedge portion.

However, in the structure of the cable connection disclosed in the Patent Literature 1, the connection is established just by elastic restoring forces of the catching portion and wedge portion. Thus, in a case where the core wire of a cable is stranded wire made from a plurality of solid wires, for example, the connection lacks stability.

### CITATION LIST

### Patent Literature

Patent Literature 1: Japanese Patent Application Laid-Open No. Hei. 9-245862

### SUMMARY

### Technical Problem

An object of the present invention is to provide a structure of a socket contact that can establish connection with high contact reliability just by inserting a core wire of a cable.

### Solution to Problem

In the structure of a socket contact according to one aspect of the present invention, for connecting a core wire of a cable by insertion thereof, the socket contact includes a terminal contact for establishing electric connection with the core wire, and an elastic contact. The terminal contact has a contact portion for coming in contact with a side part of the core wire, and regulators erected on both sides of the contact portion in a width direction. The elastic contact has a retainer and a pusher for the core wire that are opposite to the contact portion of the terminal contact.

The terminal contact and the elastic contact may be formed into an integral unit.

It should be noted that when the terminal contact is made of a material of high conductivity, such as a copper plate, the terminal contact may not have sufficient elasticity required.

In one aspect of the present invention, the terminal contact and the elastic contact may be formed separately, and the elastic contact may have a housing engagement portion to be engaged in a housing in which the socket contact is fitted, and a terminal engagement portion to be engaged with the terminal contact.

According to one aspect of the present invention, the socket contact has the regulators erected on both the sides of the contact portion of the terminal contact in the width direction, in addition to the pusher and the retainer formed in the elastic contact to push a core wire of a cable to the terminal contact. Therefore, since the core wire is contained in a recessed portion formed by the contact portion and the regulators provided on both sides, it is possible to prevent the core wire from departing from the right position or from widening in a case, for example, in which the core wire is stranded wire, and thus resulting in good connection stability.

### BRIEF DESCRIPTION OF DRAWINGS

FIG. 1A is a diagram illustrating the structure of a socket contact.

FIG. 1B is a diagram illustrating the connection structure in the state of inserting a core wire of a cable into the socket contact.

FIG. 1C is a diagram illustrating the structure of the socket contact fitted in a housing.

FIG. 1D is a diagram illustrating the state of inserting the core wire of the cable thereinto for connection.

FIG. 2A is a diagram illustrating the state of fitting an elastic contact in the housing.

FIG. 2B is a diagram illustrating the state of fitting a terminal contact in the housing.

FIG. 2C is a diagram illustrating the structure of the socket contact fitted in the housing.

FIG. 3A is a diagram illustrating an example of the shape of the terminal contact.

FIG. 3B is a diagram illustrating an example of the shape of the terminal contact.

FIG. 3C is a diagram illustrating an example of the shape of the elastic contact.

FIG. 3D is a diagram illustrating an example of the shape of the elastic contact.

FIG. 4A is a diagram illustrating the state of attaching the elastic contact to the terminal contact.

FIG. 4B is a diagram illustrating the state of attaching the elastic contact to the terminal contact.

FIG. 5A is a cross-sectional view illustrating the state of fitting the socket contacts in a housing of a terminal board.

FIG. 5B is an external appearance view of FIG. 5A.

### DESCRIPTION OF EMBODIMENTS

An example of the structure of a socket contact according to one embodiment of the present invention will be described with reference to the drawings, but the present invention is not limited thereto.

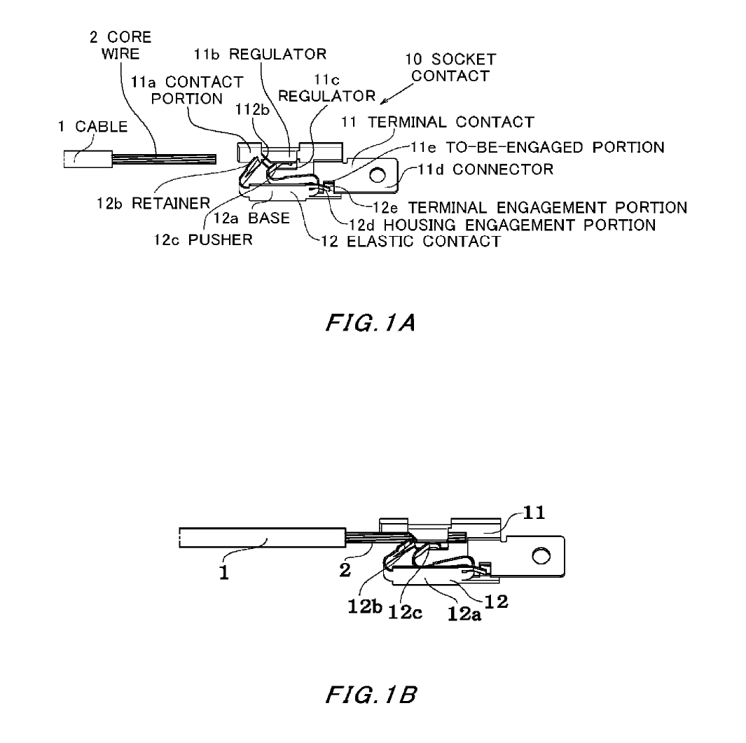

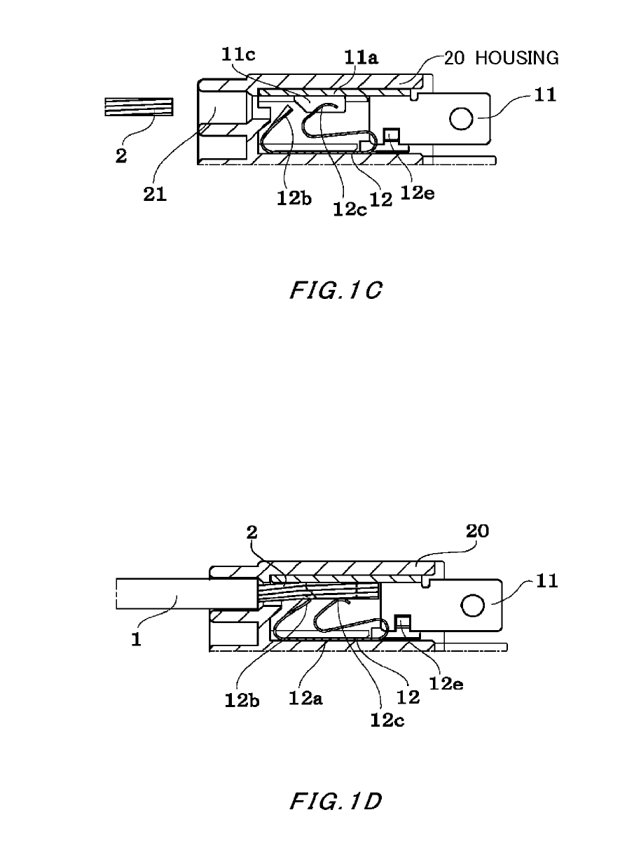

FIGS. 1A and 1B illustrate only the socket contact, and FIGS. 1C and 1D illustrate the socket contact fitted into a housing.

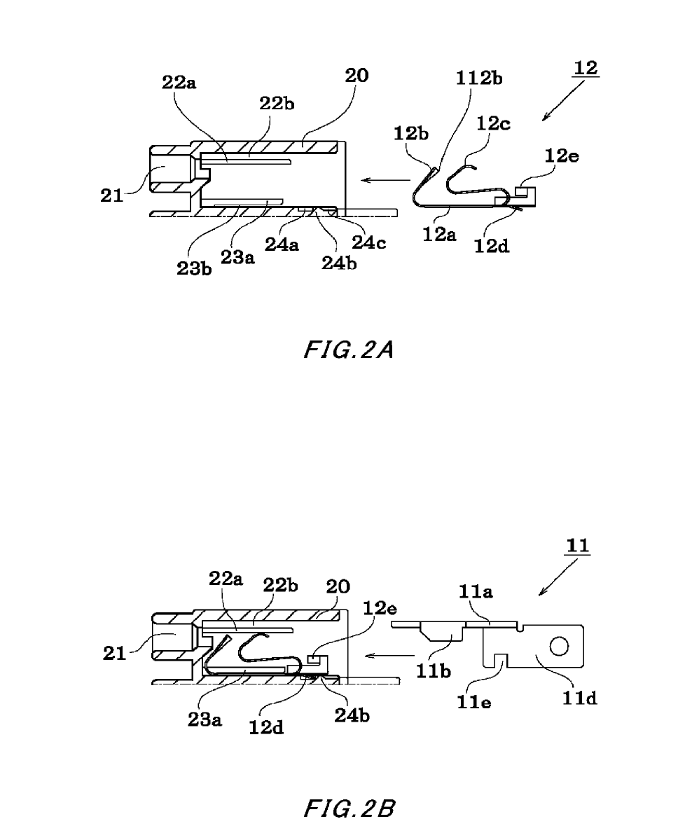

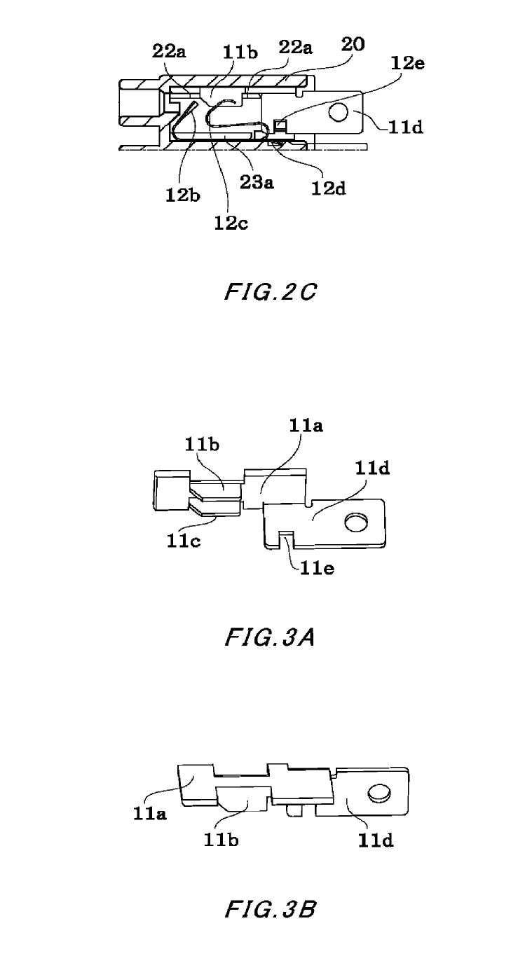

FIGS. 2A to 2C illustrate an assembly procedure for the socket contact.

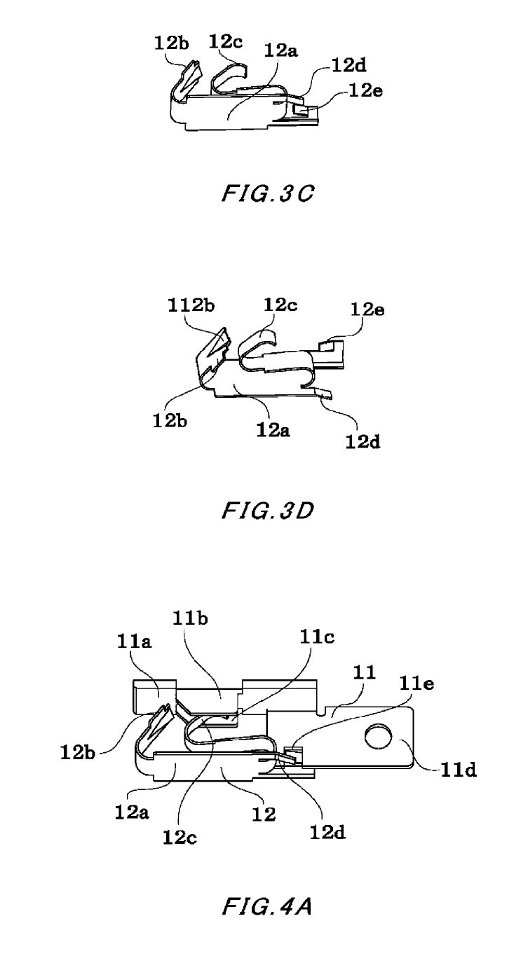

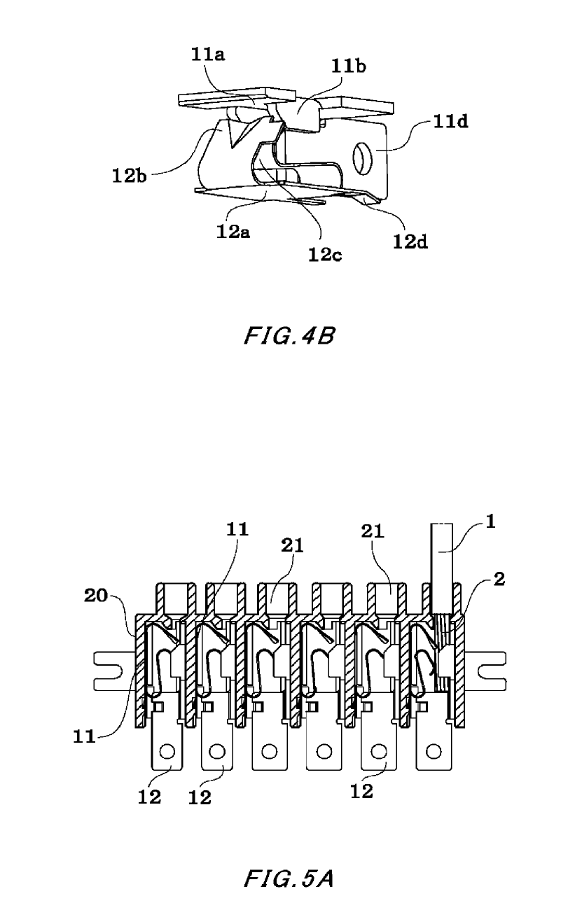

FIGS. 3A to 3D illustrate examples of the shapes of parts, i.e. a terminal contact and an elastic contact constituting the socket contact, and FIGS. 4A and 4B are assembly diagrams thereof.

In a socket contact 10 according to one embodiment of the present invention, a terminal contact 11 and an elastic contact 12 are formed separately in this embodiment, though these component elements may be formed into an integral unit.

The terminal contact 11 has a contact portion 11a for holding a core wire of a cable to be inserted while being in contact with a side part of the core wire, and a connector 11d provided behind the contact portion 11a to establish connection with an electric circuit board and other electric devices.

The connector 11d extends from the rear of the contact portion 11a in such a manner that it is folded at a substantially right angle in this embodiment, but may take another form.

The contact portion 11a has a pair of regulators 11b and 11c folded and erected on both sides of the contact portion 11a in a width direction. The pair of regulators 11b and 11c and the contact portion 11a form a recessed portion in which a core wire 2 is connected.

The regulators 11b and 11c provided on both the sides of the contact portion 11a prevent a core wire from widening, when the elastic contact 12 to be described later pushes the core wire from the side opposite to the contact portion 11a, thus resulting in good connection stability.

In this embodiment, a to-be-engaged portion 11e is formed in the connector 11d of the terminal contact 11 by cutting out a part of the connector 11d.

The elastic contact 12 is made of an elastic material by press molding or the like.

A retainer 12b and a pusher 12c are molded in such a manner that they are folded from a plate-like base 12a to the side of the contact portion 11a of the terminal contact 11.

A tip end portion of the retainer 12b faces obliquely rearward. When the core wire 2 tries to move in the direction of being pulled out, the tip end portion of the retainer 12b is engaged in a side part of the core wire 2, thus preventing the pullout.

In this embodiment, a guide notch 112a in the shape of a triangular pyramid in cross-section is formed in the tip end portion, to thereby facilitate inserting a core wire.

A contact point of the pusher 12c is situated between the regulators 11b and 11c of the terminal contact 11. A tip end portion of the pusher 12c is folded back to the side of the base 12a, and the pusher 12c comes in contact with a side part of the core wire 2 with a curved surface.

In this embodiment, the elastic contact 12 has a housing engagement portion 12d that is elastically engaged and stopped in the internal side surface of a housing 20 to be described later at the rear of the base 12a, and a terminal engagement portion 12e that is engaged and stopped in the to-be-engaged portion 11e cut out of the terminal contact 11.

FIGS. 2A to 2C illustrate a procedure for assembling the socket contact into the housing 20 of a terminal board or the like.

As illustrated in FIG. 2A, the housing 20 has grooves into each of which each of the terminal contact 11 and the elastic contact 12 is inserted from the rear side of an insertion opening 21 for the cable 1.

Both the side edges of the base 12a of the elastic contact 12 are inserted into opposite grooves 23b, which are formed under ledges 23a provided at the corners of the side surfaces of the housing 20, and the housing engagement portion 12d is lance-engaged in a to-be-engaged portion 24b provided in the housing 20.

In this embodiment, a guide recess 24c is provided behind the to-be-engaged portion 24b, and a recessed portion 24a for fitting the housing engagement portion 12d therein is formed in front of the projection 24b.

Then, as illustrated in FIG. 2B, when both the side edges of the contact portion 11a of the terminal contact 11 are inserted into grooves 22b, which are formed by ledges 22a provided at the corners opposite to the above-described grooves 23b inside the housing 20, the terminal engagement portion 12e of the elastic contact 12 is lance-engaged in the to-be-engaged portion 11e of the terminal contact 11 as illustrated in FIG. 2C, and hence the terminal contact 11 and the elastic contact 12 are engaged with each other. FIGS. 4A and 4B illustrate the engagement state of the terminal contact 11 and the elastic contact 12.

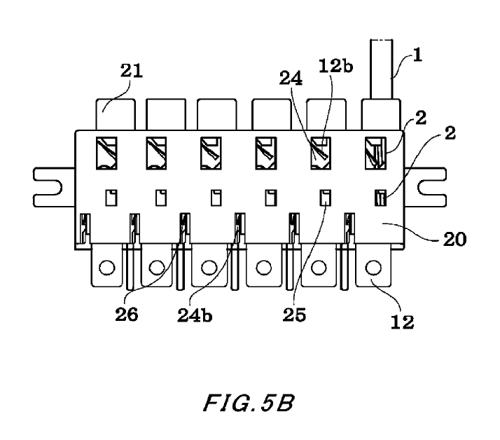

FIGS. 5A and 5B illustrate an example of the terminal board to which the structure of a socket contact according to one embodiment of the present invention is applied.

A plurality of socket contacts are fitted in parallel in the housing 20. The housing 20 has openings 24 through which the retainers 12b can be seen, insertion check windows 25 for allowing the insertion of core wires to be checked therethrough, and stopper check windows 26 for allowing the engagement of the housing engagement portions 12d to be checked therethrough.

To detach the cable 1, the retainer 12b is opened by a tip of a tool such as a screwdriver inserted into the opening 24.

### REFERENCE SIGNS LIST

1 cable
2 core wire
10 socket contact
11 terminal contact
11a contact portion
11b regulator
11c regulator
11d connector
11e to-be-engaged portion
12 elastic contact
12a base
12b retainer
12c pusher
12d housing engagement portion
12e terminal engagement portion

1. A structure of a socket contact for connecting a core wire of a cable by insertion thereof, the socket contact comprising a terminal contact for establishing electric connection with the core wire, and an elastic contact, wherein
the terminal contact has a contact portion for coming in contact with a side part of the core wire, and regulators erected on both sides of the contact portion in a width direction, and
the elastic contact has a retainer and a pusher for the core wire that are opposite to the contact portion of the terminal contact.

2. The structure of a socket contact according to claim 1, wherein:
the terminal contact and the elastic contact are formed separately; and
the elastic contact has a housing engagement portion to be engaged in a housing in which the socket contact is fitted, and a terminal engagement portion to be engaged with the terminal contact.
